(19) United States
(12) Patent Application Publication
(10) Pub. No.: US 2017/0170689 A1
(43) Pub. Date: Jun. 15, 2017

(54) WIRELESS CHARGING OF METAL FRAMED ELECTRONIC DEVICES

(71) Applicant: QUALCOMM Incorporated, San Diego, CA (US)

(72) Inventor: Seong Heon Jeong, San Diego, CA (US)

(21) Appl. No.: 15/376,318

(22) Filed: Dec. 12, 2016

Related U.S. Application Data
(60) Provisional application No. 62/267,199, filed on Dec. 14, 2015.

(51) Int. Cl. H02J 50/12; H02J 50/80; H02J 7/02

(52) U.S. Cl. CPC H02J 50/12; H02J 7/025; H02J 50/80

(57) ABSTRACT

A method and system for providing wireless power transfer via a metal frame by forming a coil conductor from the metal frame from a plurality of holes and a plurality of slits positioned around the metal frame, where the plurality of holes and the plurality of slits are filled with a non-conductive material or open air. The method and system utilize the coil conductor that is connected to transmitter or receiver circuits to enable wireless power transfer and communications.

### CLAIM OF PRIORITY UNDER 35 U.S.C. §119

The present application for patent claims priority to Provisional Application No. 62/267,199 entitled “WIRELESS CHARGING OF METAL FRAMED ELECTRONIC DEVICES” filed Dec. 14, 2015, and assigned to the assignee hereof. The content of Provisional Application No. 62/267,199 is hereby expressly incorporated by reference herein in its entirety.

### TECHNICAL FIELD

The described technology generally relates to wireless power. More specifically, the disclosure is directed to devices, systems, and methods related to transferring wireless power by a wireless power charging system via a metal object, for example the metal frame of a camera.

### BACKGROUND

In wireless power applications, wireless power charging systems may provide the ability to charge and/or power electronic devices without physical, electrical connections, thus reducing the number of components required for operation of the electronic devices and simplifying the use of the electronic device. Such a wireless power charging system may comprise a transmitter coupler and other transmitting circuits configured to generate a magnetic field that may induce a current in a receiver coupler that may be connected to the electronic device to be charged or powered wirelessly. Similarly, the electronic device may comprise a receiver coupler and other receiving circuits configured to generate a current when the receiver coupler is exposed to the magnetic field. Many of these devices may be designed with metal frames or chasses. There is a need for a system and method for performing wireless power transfer to be able to incorporate wireless charging within such a device.

### SUMMARY

The implementations disclosed herein each have several innovative aspects, no single one of which is solely responsible for the desirable attributes of the invention. Without limiting the scope, as expressed by the claims that follow, the more prominent features will be briefly disclosed here. After considering this discussion, one will understand how the features of the various implementations provide several advantages over current wireless charging systems.

One aspect of the invention includes an apparatus for wirelessly receiving power from a transmitter. The apparatus comprises a metal frame configured to support a component of the apparatus. The metal frame has a plurality of holes and a plurality of slits. Each slit of the plurality of slits connects a hole of the plurality of holes or a slit of the plurality of slits with one of another hole, another slit, or an edge of the metal frame. The plurality of holes and the plurality of slits are positioned to form a coil from the metal frame. The apparatus also comprises a receive circuit that comprises the coil and is configured to inductively couple power via a magnetic field generated by the transmitter to power or charge a load electrically coupled to the receive circuit.

Another aspect of the invention includes another apparatus for wirelessly receiving power from a transmitter. The other apparatus comprises a casing and a frame. The frame as a shape defined to provide structural support for the apparatus. The frame also has a plurality of one or more holes defining positioned around the frame so as to provide access between an inside and an outside of the frame. The frame further has a plurality of one or more slits configured to connect a hole of the one or more holes or a slit of the one or more slits with one of another hole, another slit, or an edge of the metal frame. The receive circuit comprises a metal portion forming a portion of the frame. The metal portion comprises the plurality of one or more holes and the plurality of one or more slits. The receive circuit is configured to inductively couple power via a magnetic field generated by the transmitter to power or charge a load electrically coupled to the receive circuit. The metal portion of the frame having the plurality of one or more holes and the plurality of one or more slits defines a path for electrical current to flow in the metal portion substantially around the frame in response to a voltage induced by the magnetic field.

Another aspect of the invention includes a method of wirelessly receiving power at an apparatus from a transmitter. The method comprises inductively coupling power via a magnetic field generated by the transmitter via a receive circuit comprising a coil formed from a metal frame configured to support a component of the apparatus. The metal frame has a plurality of holes and a plurality of slits positioned around the metal frame, each slit of the plurality of slits connecting a hole of the plurality of holes or a slit of the plurality of slits with one of another hole, another slit, or an edge of the metal frame, the plurality of holes and the plurality of slits positioned to form the coil. The method also comprises powering or charging a load of the apparatus using the inductively coupled power.

Another aspect of the invention includes an apparatus for receiving wireless power from a transmitter. The apparatus comprises means for inductively coupling power via a magnetic field generated by the transmitter, wherein a current induced by the magnetic field has a current path about a plurality of holes and a plurality of slits, each slit of the plurality of slits connecting a hole of the plurality of holes or a slit of the plurality of slits with one of another hole, another slit, or an edge of the metal frame. The apparatus further comprises means for powering or charging a load of the apparatus using the inductively coupled power.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations, however, are merely examples and are not intended to be limiting. Throughout the drawings, similar symbols typically identify similar components, unless context dictates otherwise. Note that the relative dimensions of the following figures may not be drawn to scale.

FIG. 1 is a functional block diagram of a wireless power transfer system, in accordance with one exemplary implementation.

FIG. 2 is a functional block diagram of a wireless power transfer system, in accordance with another exemplary implementation.

FIG. 3 is a schematic diagram of a portion of transmit circuitry or receive circuitry of FIG. 2 including a transmit or receive coupler, in accordance with exemplary implementations.

FIG. 4 is a simplified functional block diagram of a transmitter that may be used in an inductive power transfer system, in accordance with exemplary implementations of the invention.

FIG. 5 is a simplified functional block diagram of a receiver that may be used in the inductive power transfer system, in accordance with exemplary implementations of the invention.

FIG. 6A depicts an isometric view of a metal frame having one or more holes on each of one or more sides of the metal frame.

FIG. 6B depicts a planar view of the top side of the metal frame having a plurality of holes, the metal frame further including a plurality of slits.

FIG. 6C depicts a back view of the top side of the metal frame having the plurality of holes and slits including a protective layer and a plurality of wires.

FIG. 7A depicts an exploded perspective view of a laptop computer having a plurality of holes and slits arranged to form a coil from the laptop chassis.

FIG. 7B depicts a perspective view of a desktop computer chassis having a plurality of holes and slits arranged to form a coil from the desktop computer chassis.

FIG. 8A depicts an image of the coil formed by the top side of the metal frame having one or more components that create a slot antenna having a current path about the slits and the holes.

FIG. 8B depicts another view of the coil forming the slot antenna of FIG. 8A showing the current path about the slits and the holes of the top side of the metal frame.

FIG. 9 depicts a series of graphs indicating radiation patterns of the coils of FIGS. 8A and 8B as compared to radiation patterns of a dipole antenna.

FIG. 10 depicts an image of the coil formed from the top side of the metal frame being adapted for improved electromagnetic interference reduction and mechanical robustness, in accordance with an exemplary implementation.

FIG. 11 depicts a flowchart of an exemplary method of wirelessly receiving power at an apparatus from a transmitter, in accordance with an exemplary implementation.

### DETAILED DESCRIPTION

Various aspects of the novel systems, apparatuses, and methods are described more fully hereinafter with reference to the accompanying drawings. The teachings of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless power transfer technologies and system configurations, some of which are illustrated by way of example in the figures and in the following description of the preferred aspects. The detailed description and drawings are merely illustrative of the disclosure rather than limiting, the scope of the disclosure being defined by the appended claims and equivalents thereof.

In the following detailed description, reference is made to the accompanying drawings, which form a part of the present disclosure. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure.

The terminology used herein is for the purpose of describing particular implementations only and is not intended to be limiting of the disclosure. It will be understood by those within the art that if a specific number of a claim element is intended, such intent will be explicitly recited in the claim, and in the absence of such recitation, no such intent is present. For example, as used herein, the singular forms “a”, “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “receive coupler” to achieve power transfer.

FIG. 1 is a functional block diagram of a wireless power transfer system 100, in accordance with one exemplary implementation. Input power 102 is provided to a transmit coupler 114 of a transmitter 104 from a power source (not shown in this figure) to generate a wireless (e.g., magnetic or electromagnetic) field 105 for performing energy transfer. A receive coupler 118 of a receiver 108 couples to the wireless field 105 and generates an output power 110 for storing or consumption by a device (not shown in this figure) coupled to the output power 110. Both the transmitter 104 and the receiver 108 are separated by a distance 112.

The receiver 108 may wirelessly receive power when the receive coupler 118 is located in the wireless field 105 generated by the transmit coupler 114. The transmit coupler 114 of the transmitter 104 may transmit energy to the receive coupler 118 via the wireless field 105. The receive coupler 118 of the receiver 108 may receive or capture the energy transmitted from the transmitter 104 via the wireless field 105. The wireless field 105 corresponds to a region where energy output by the transmit coupler 114 may be captured by the receive coupler 118. In some implementations, the wireless field 105 may correspond to the “near-field” of the transmitter 104. The “near-field” may correspond to a region in which there are strong reactive fields resulting from the currents and charges in the transmit coupler 114 that minimally radiate power away from the transmit coupler 114 in the far field. The near-field may correspond to a region that is within about one wavelength (or a fraction thereof) of the transmit coupler 114.

In one exemplary implementation, the wireless field 105 may be a magnetic field and the transmit coupler 114 and the receive coupler 118 are configured to inductively transfer power. The transmit coupler and the receive coupler 118 may further be configured according to a mutual resonant relationship. When the resonant frequency of the receive coupler 118 and the resonant frequency of the transmit coupler 114 are substantially the same or very close, transmission losses between the transmitter 104 and the receiver 108 are reduced. Resonant inductive coupling techniques may thus allow for improved efficiency and power transfer over various distances and with a variety of coupler configurations. When configured according to a mutual resonant relationship, in an implementation, the transmitter 104 outputs a time varying magnetic field with a frequency corresponding to the resonant frequency of the transmit coupler 114. When the receive coupler 118 is within the wireless field 105, the time varying magnetic field may induce a current in the receive coupler 118. When the receive coupler 118 is configured to resonate at the frequency of the transmit coupler 114, energy may be more efficiently transferred. The alternating current (AC) induced in the receive coupler 118 may be rectified to produce direct current (DC) that may be provided to charge or to power a load (not shown).

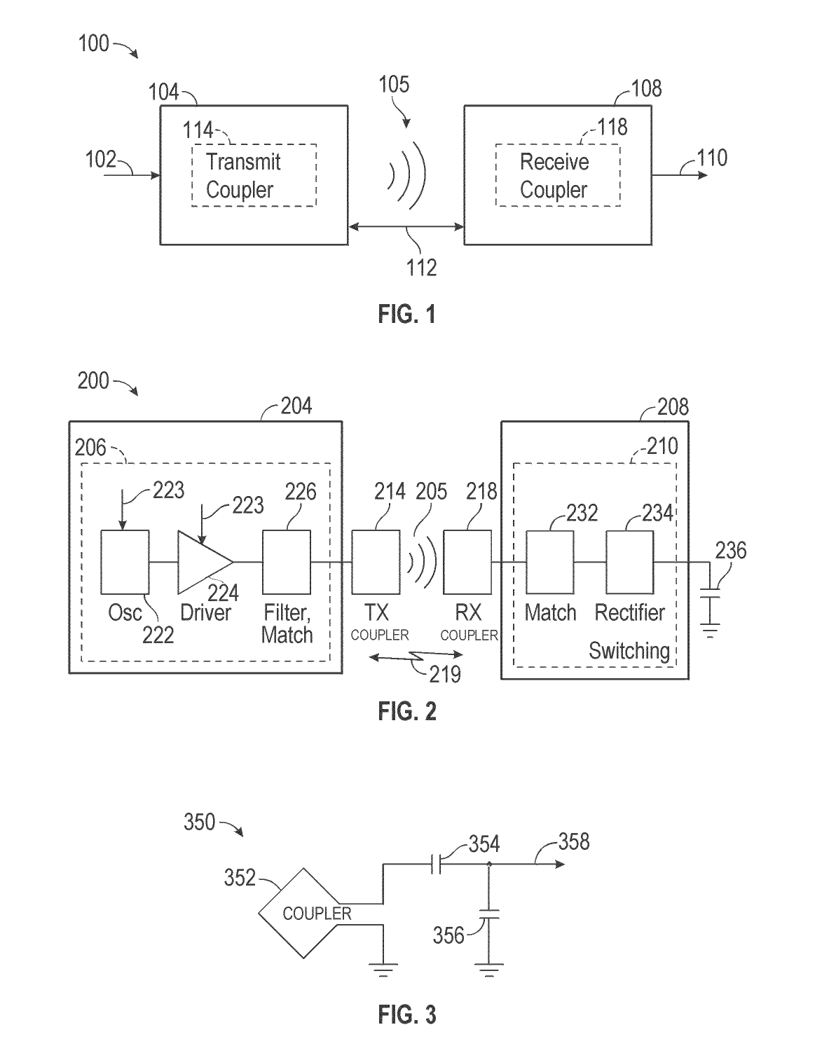

FIG. 2 is a functional block diagram of a wireless power transfer system 200, in accordance with an exemplary implementation. The system 200 includes a transmitter 204 and a receiver 208. The transmitter 204 includes transmit circuitry 206 that includes an oscillator 222, a driver circuit 224, and a filter and matching circuit 226. The oscillator 222 may be configured to generate a signal at a desired frequency that is adjusted in response to a frequency control signal 223. The oscillator 222 provides the oscillator signal to the driver circuit 224. The driver circuit 224 is configured to drive a transmit coupler 214 at, for example, a resonant frequency of the transmit coupler 214 based on an input voltage signal (VD) 225. The driver circuit 224 may be a switching amplifier configured to receive a square wave from the oscillator 222 and output a sine wave or square wave.

The filter and matching circuit 226 filters out harmonics or other unwanted frequencies and matches the impedance of the transmitter 204 to the transmit coupler 214. The transmit coupler 214 may generate a wireless field 205 to wirelessly output power at a level sufficient for charging a battery 236.

The receiver 208 includes receive circuitry 210 that includes a matching circuit 232 and a rectifier circuit 234. The matching circuit 232 may match the impedance of the receive circuitry 210 to the receive coupler 218. The rectifier circuit 234 may generate a direct current (DC) power output from an alternating current (AC) power input to charge the battery 236. The receiver 208 and the transmitter 204 may additionally communicate on a separate communication channel 219 (e.g., Bluetooth, ZigBee, cellular, etc.). The receiver 208 and the transmitter 204 may alternatively communicate via in-band signaling using characteristics of the wireless field 205.

FIG. 3 is a schematic diagram of a portion of transmit circuitry 206 or receive circuitry 210 of FIG. 2, in accordance with exemplary implementations. As illustrated in FIG. 3, the transmit or receive circuitry 350 may include a coupler 352. The coupler 352 may also be referred to herein or be configured as a “magnetic” coupler or an induction coil. The term “coupler” generally refers to a component that wirelessly outputs or receives energy for coupling to another “coupler.” The coupler 352 may also be referred to as a coil or inductor of a type that is configured to wirelessly output or receive power. As used herein, the coupler 352 is an example of a “power transfer component” of a type that is configured to wirelessly output and/or receive power. The coupler 352 may include an air core or a physical core such as a ferrite core (not shown in this figure).

The coupler 352 may form a portion of a resonant circuit configured to resonate at a resonant frequency. The resonant frequency of the loop or magnetic coupler 352 is based on the inductance and capacitance. Inductance may be simply the inductance created by the coupler 352, whereas, a capacitor may be added to create a resonant structure at a desired resonant frequency. As a non-limiting example, a capacitor 354 and a capacitor 356 are added to the transmit or receive circuitry 350 to create a resonant circuit that resonates at a desired frequency of operation. Accordingly, for larger diameter couplers, the size of capacitance needed to sustain resonance may decrease as the diameter or inductance of the loop increases. Other resonant circuits formed using other components are also possible.

As another non-limiting example, a capacitor (not shown) may be placed in parallel between the two terminals of the circuitry 350. For transmit couplers, a signal 358, with a frequency that substantially corresponds to the resonant frequency of the coupler 352, may be an input to the coupler 352. For receive couplers, the signal 358, with a frequency that substantially corresponds to the resonant frequency of the coupler 352, may be an output from the coupler 352.

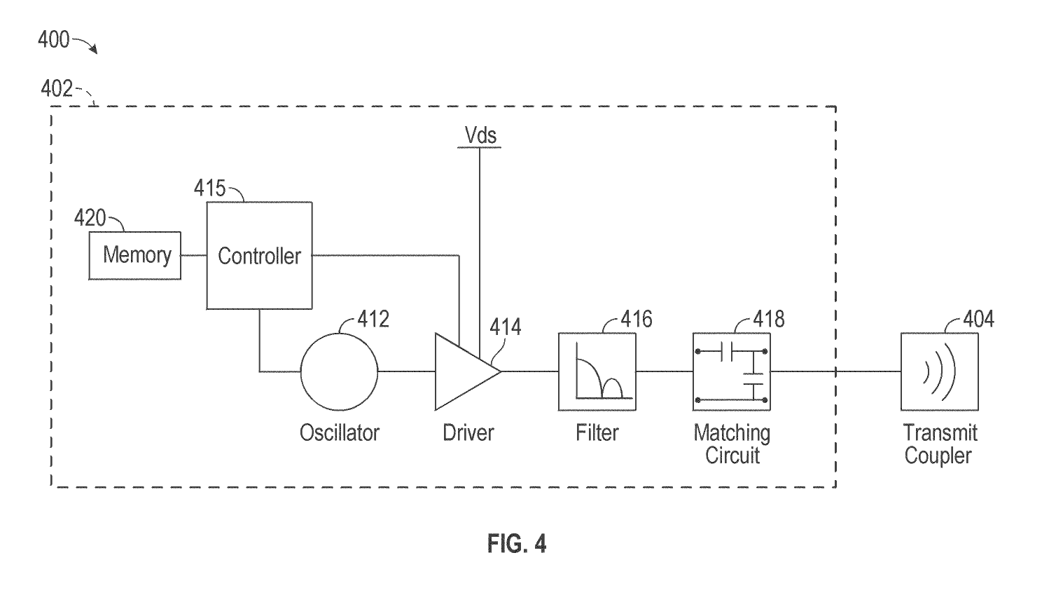

FIG. 4 is a simplified functional block diagram of a transmitter 400 that may be used in an inductive power transfer system, in accordance with exemplary implementations of the invention. The transmitter 400 includes transmit circuitry 402 and a transmit coupler 404 operably coupled to the transmit circuitry 402. In some implementations, the transmit coupler 404 is configured as the transmit coupler 214 as described above in reference to FIG. 2. In some implementations, the transmit coupler 404 is or may be referred to as a coil (e.g., an induction coil). In other implementations the transmit coupler 404 is associated with a larger structure, such as a table, mat, lamp, or other stationary configuration. In an exemplary implementation, the transmit coupler 404 is configured to generate an electromagnetic or magnetic field within a charging region. In an exemplary implementation, the transmit coupler 404 is configured to transmit power to a receiver device within the charging region at a power level sufficient to charge or power the receiver device.

The transmit circuitry 402 may receive power through a number of power sources (not shown). The transmit circuitry 402 may include various components configured to drive the transmit coupler 404. In some exemplary implementations, the transmit circuitry 402 may be configured to adjust the transmission of wireless power based on the presence and constitution of the receiver devices as described herein. As such, the transmit circuitry 402 may provide wireless power efficiently and safely.

The transmit circuitry 402 includes a controller 415. In some implementations, the controller 415 may be a micro-controller or a processor. In other implementations, the controller 415 may be implemented as an application-specific integrated circuit (ASIC). The controller 415 may be operably connected, directly or indirectly, to each component of the transmit circuitry 402. The controller 415 may be further configured to receive information from each of the components of the transmit circuitry 402 and perform calculations based on the received information. The controller 415 may be configured to generate control signals for each of the components that may adjust the operation of that component. As such, the controller 415 may be configured to adjust the power transfer based on a result of the calculations performed by it.

The transmit circuitry 402 may further include a memory 420 operably connected to the controller 415. The memory 420 may comprise random-access memory (RAM), electrically erasable programmable read only memory (EEPROM), flash memory, or non-volatile RAM. The memory 420 may be configured to temporarily or permanently store data for use in read and write operations performed by the controller 415. For example, the memory 420 may be configured to store data generated as a result of the calculations of the controller 415. As such, the memory 420 allows the controller 415 to adjust the transmit circuitry 402 based on changes in the data over time.

The transmit circuitry 402 may further include an oscillator 412 operably connected to the controller 415. In some implementations, the oscillator 412 is configured as the oscillator 222 as described above in reference to FIG. 2. The oscillator 412 may be configured to generate an oscillating signal at the operating frequency of the wireless power transfer. For example, in some exemplary implementations, the oscillator 412 is configured to operate at the 6.78 MHz ISM frequency band. The controller 415 may be configured to selectively enable the oscillator 412 during a transmit phase (or duty cycle). The controller 415 may be further configured to adjust the frequency or a phase of the oscillator 412 which may reduce out-of-band emissions, especially when transitioning from one frequency to another. As described above, the transmit circuitry 402 may be configured to provide an amount of charging power to the transmit coupler 404, which may generate energy (e.g., magnetic flux) about the transmit coupler 404.

The transmit circuitry 402 further includes a driver circuit 414 operably connected to the controller 415 and the oscillator 412. The driver circuit 414 may be configured as the driver circuit 224 as described above in reference to FIG. 2. The driver circuit 414 may be configured to drive the signals received from the oscillator 412, as described above.

The transmit circuitry 402 may further include a low pass filter (LPF) 416 operably connected to the transmit coupler 404. The low pass filter 416 may be configured as the filter portion of the filter and matching circuit 226 as described above in reference to FIG. 2. In some exemplary implementations, the low pass filter 416 may be configured to receive and filter an analog signal of current and an analog signal of voltage generated by the driver circuit 414. In some implementations, the low pass filter 416 may alter a phase of the analog signals. The low pass filter 416 may cause the same amount of phase change for both the current and the voltage, canceling out the changes. In some implementations, the controller 415 may be configured to compensate for the phase change caused by the low pass filter 416. The low pass filter 416 may be configured to reduce harmonic emissions to levels that may prevent self-jamming. Other exemplary implementations may include different filter topologies, such as notch filters that attenuate specific frequencies while passing others.

The transmit circuitry 402 may further include a fixed impedance matching circuit 418 operably connected to the low pass filter 416 and the transmit coupler 404. The matching circuit 418 may be configured as the matching portion of the filter and matching circuit 226 as described above in reference to FIG. 2. The matching circuit 418 may be configured to match the impedance of the transmit circuitry 402 (e.g., 50 ohms) to the transmit coupler 404. Other exemplary implementations may include an adaptive impedance match that may be varied based on measurable transmit metrics, such as the measured output power to the transmit coupler 404 or a DC current of the driver circuit 414.

The transmit circuitry 402 may further comprise discrete devices, discrete circuits, and/or an integrated assembly of components.

Transmit coupler 404 may be implemented as an antenna strip with the thickness, width and metal type selected to keep resistive losses low. In one implementation, the transmit coupler 404 can generally be configured for association with a larger structure such as a table, mat, lamp or other less portable configuration. In an exemplary application where the transmit coupler 404 may be larger in size relative to the receive coupler, the transmit coupler 404 will not necessarily need a large number of turns to obtain a reasonable inductance to form a portion of a resonant circuit tuned to a desired operating frequency.

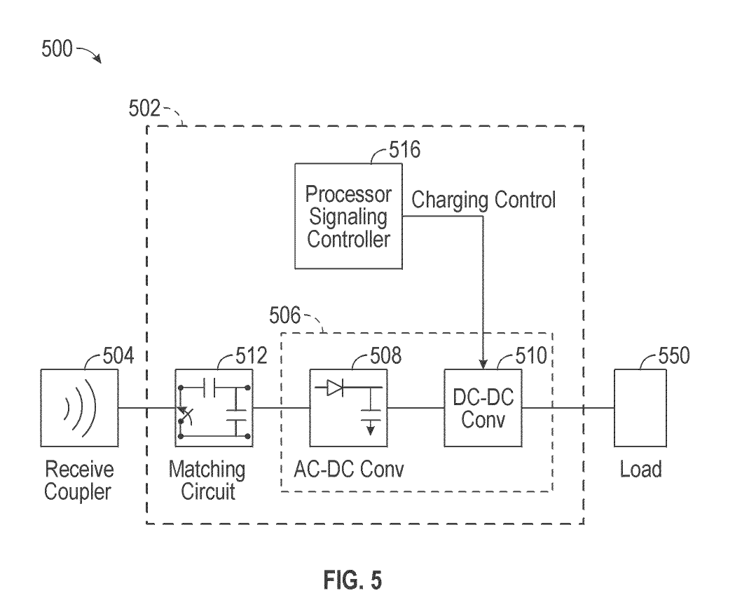

FIG. 5 is a block diagram of a receiver that may be used in the inductive power transfer system, in accordance with an implementation. A receiver 500 includes a receive circuitry 502, a receive coupler 504, and a load 550. The receiver circuitry 502 is electrically coupled to the load 550 for providing received charging power thereto. It should be noted that receiver 500 is illustrated as being external to load 550 but may be integrated into load 550. The receive coupler 504 is operably connected to the receive circuitry 502. The receive coupler 504 may be configured as the receive coupler 218 as described above in reference to FIG. 2/FIG. 3. In some implementations, the receive coupler 504 may be tuned to resonate at a frequency similar to a resonant frequency of the transmit coupler 404, or within a specified range of frequencies, as described above. The receive coupler 504 may be similarly dimensioned with transmit coupler 404 or may be differently sized based upon the dimensions of the load 550. The receive coupler 504 may be configured to couple to the magnetic field generated by the transmit coupler 404, as described above, and provide an amount of received energy to the receive circuitry 502 to power or charge the load 550.

The receive circuitry 502 is operably coupled to the receive coupler 504 and the load 550. The receive circuitry may be configured as the receive circuitry 210 as described above in reference to FIG. 2. The impedance presented to the receive coupler 504 by the receive circuitry 502 may be configured to match an impedance of the receive coupler 504 (e.g., via a matching circuit 512), which increase efficiency. The receive circuitry 502 may be configured to generate power based on the energy received from the receive coupler 504. The receive circuitry 502 may be configured to provide the generated power to the load 550. In some implementations, the receiver 500 may be configured to transmit a signal to the transmitter 400 indicating an amount of power received from the transmitter 400.

The receive circuitry 502 includes a processor-signaling controller 516 configured to coordinate the processes of the receiver 500.

The receive circuitry 502 includes power conversion circuitry 506 for converting a received energy source into charging power for use by the load 550. The power conversion circuitry 506 includes an AC-to-DC converter 508 coupled to a DC-to-DC converter 510. The AC-to-DC converter 508 rectifies the AC signal from the receive coupler 504 into DC power while the DC-to-DC converter 510 converts the rectified energy signal into an energy potential (e.g., voltage) that is compatible with the load 550. Various AC-to-DC converters 508 are contemplated including partial and full rectifiers, regulators, bridges, doublers, as well as linear and switching converters.

The receive circuitry 502 may further include the matching circuit 512 configured to connect the receive coupler 504 to the power conversion circuitry 506 or alternatively for disconnecting the power conversion circuitry 506 from the receive coupler 504. Disconnecting the receive coupler 504 from the power conversion circuitry 506 may not only suspend charging of the load 550, but also changes the “load” as “seen” by the transmitter 400 (FIG. 4) as is explained more fully below.

The wireless power circuitry described above, and particularly the receive circuitry 502, is intended to be incorporated into a variety of portable electronic devices. Some portable devices may have housings, casings, or other portions that are made of a variety of materials including metal. Metal housing or casing portions may be affected by wireless power transfer. For example, in an inductive charging system, a magnetic field generated by a transmitter 400 (FIG. 4) may induce a voltage on the metal housing portion that generate eddy currents within the metal housing that under certain circumstances that could cause further losses or prevent a receiver coupler 504 from coupling to the magnetic field. Certain aspects of various implementations described herein are related to incorporating wireless power circuitry into devices with metal covers/housings/casings while overcoming various challenges associated with the metal covers/housings/casings.

Various electronic devices may comprise a metal frame or chassis or cover. The metal frame may provide structural support for the device and protect components located within the metal frame from exposure or damage. For example, a desktop computer may comprise a metal frame as part of its case, where the metal frame protects electronic components from being crushed by other objects. In some implementations, the metal frame may include various holes or openings, for example openings for ventilation, I/O, power supply, etc. Additionally, non-electronic objects or devices that may be used in proximity of electronic devices may also have a metal frame or chassis. These objects may also comprise various holes or openings, for example holes for screws or other fastening means.

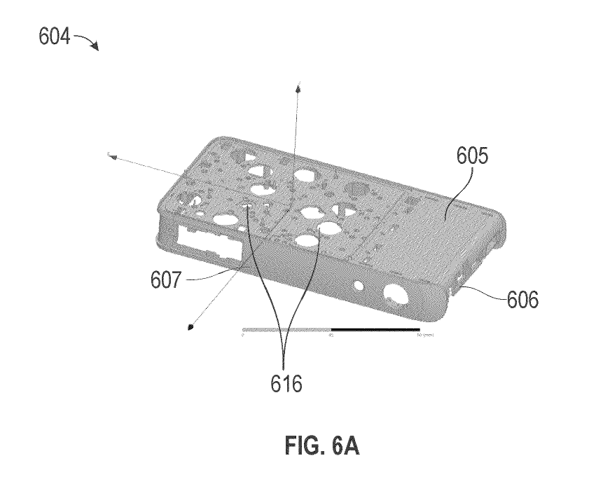

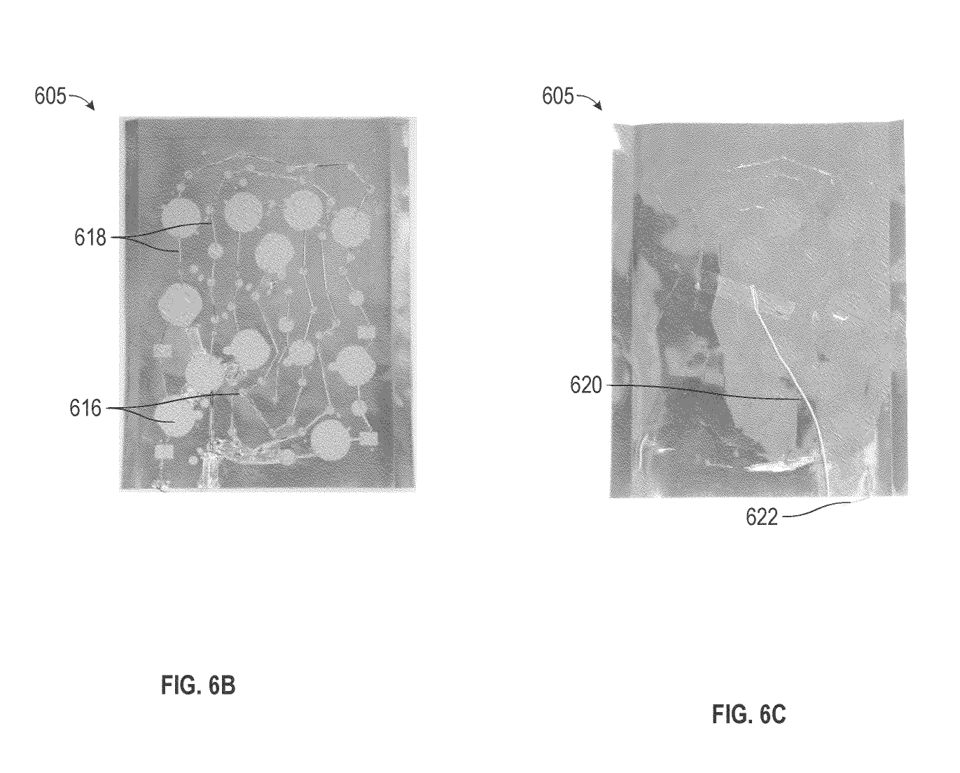

FIG. 6A depicts an isometric view of a metal frame 604 having one or more holes 616 on each of one or more sides of the metal frame 604. As shown, the metal frame 604 may comprise at least three sides or faces (e.g., top side 605, right side 606, and front side 607). The one or more sides may be in different planes or in the same plane, or a combination thereof. The one or more holes 616 may allow access to components inside the metal frame 604 outside the metal frame 604, or vice versa. For example, front side 607 is shown comprising three holes of varying size and shape. In some implementations, one of these holes 616 may be for a volume rocker switch, another for a charging port, and the third for headphones. In some implementations, the one or more holes 616 may permit access to one or more of a camera lens, a light source, a speaker, a microphone, a charging port, a data port, an audio port, or a user interface device. In some implementations, the one or more holes 616 may be used to allow cameras, speakers, ports, switches, buttons, displays, and/or other components access to both the interior and exterior of the metal frame 604.

FIG. 6B depicts a planar view of the portion 605 (top side 605 in FIG. 6A) of the metal frame having a plurality of holes, the metal frame further including a plurality of slits (e.g., gaps or otherwise non-conductive portions). In some implementations, each slit may comprise a cut or slice through the conductive portion of the metal frame, thus creating two isolated pieces of the metal frame on either side of the slit. While many of the slits shown in FIG. 6B are linear, the slits may be of any shape, length, or width. As shown in FIG. 6B, the portion 605 includes a plurality of holes 616 that are connected to each other with a series of slits 618. Each slit 618 may connect two holes 616. Accordingly, the combination of the one or more holes 616 and the series of slits 618 may form a coil with at least one turn formed from the portion 605 of the metal frame 604 and defined by the holes 616 and slits 618. In some implementations, the combination of holes 616 and slits 618 may form a multi-turn coil from the portion 605 of the metal frame 604. In some embodiments, the combination of holes 616 and slits 618 may form a multi-turn coil from the entire device comprising the metal frame 604. In some implementations, the coil or multi-turn coil may be configured to form part of a resonant circuit, as described above in relation to FIGS. 1-3. In some embodiments, the coil formed from the portion 605 of the metal frame 604 may be coupled to one or more circuits. For example, the coil formed from the portion 605 of the metal frame 604 may be coupled to a receive circuit. Accordingly, an externally generated magnetic field, when exposed to the coil, may induce voltage in the coil that may cause a current to flow within the portion 605 along the coil defined by the holes 616 and slits 618. The receive circuit may receive the current to power or charge a load. Alternatively, or additionally, the coil formed from the portion 605 of the metal frame 604 may be coupled to a transmit circuit and may be configured to be driven with a current to generate a magnetic field. The portion 605 of the metal frame 604 shown may be a side of the frame of a portable electronic device 602 (e.g., a cell-phone, a GPS unit, a watch, a camera, a mobile media device, a laptop computer, a key fob, a computer accessory, or a tablet, etc.). In some implementations, the portion 605 of the metal frame 604 may actually be a back side of a portable electronic device not shown here (e.g., the back side of a camera or cell phone). In other implementations, the portion 605 may be a side, front, top, bottom, or other side of the metal frame 604.

In some implementations, the holes 616 and the slits 618 of FIG. 6B may be formed in the metal frame 604 during the molding process of the metal frame 604 and may not require additional processing of individual pieces or later processing to form the holes 616 or the slits 618 in the metal frame 604. Such a “single-shot” molding process and simplified handing may allow for cheaper designs while maintaining versatility of application of the metal frame 604. In some implementations, the holes 616 and the slits 618 may be created in the metal frame 604 after the metal frame 604 is formed, thus allowing for the retrofitting of existing metal frames 604 with the components described above (holes 616, slits 618, and transmitter or receiver circuits). The holes 616 and slits 618 may be used in any configuration so as to maximize the number of turns created for the coil in the metal frame 604.

The various sides (e.g., top side 605, right side 606, and front side 607 of FIG. 6A) of the metal frame 604 may mechanically couple to other sides of the metal frame 604. In some implementations, each side of the metal frame 604 may form a different and separate coil (e.g., the top side 605 of the metal frame 604 may form a coil separate from a coil formed by the right side 606 and/or the front side 607 of the metal frame 604). In some implementations, each side of the metal frame 604 may form a single, combined coil. For example, the top side 605, the right side 606, and the front side 607 of the metal frame 604 may each be part of the same coil structure.

In some implementations, the metal frame 604 may be made from mostly metal (e.g., aluminum) but may have non-metal components as well for various purposes (e.g., for holding various sides together or covering holes or slits when not in use). In some implementations, the metal frame 604 may only be partially metal and may consist of a majority of a non-metallic substance (e.g., plastic, rubber, epoxy, polyurethane, or any other non-conductive material or combination thereof). In some implementations, the device having the metal frame 604 may embody a portion of the transmitter 400 or the receiver 500 as referenced in FIGS. 4 and 5, respectively (or maybe be coupled to the circuitry of the transmitter 400 or receiver 500 as referenced in FIGS. 4 and 5).

In some implementations, the portion 605 of the metal frame 604 shown in FIG. 6B may not include the entire top side of the metal frame 604, instead including just a portion of the top side 605 (of FIG. 6A) of the metal frame 604. Accordingly, the portion 605 depicted in FIG. 6B may exist at the center of the back of the metal frame 604 or at any other location of the back of the metal frame 604 (e.g., when the coil is formed from just a portion of a side of the metal frame 604). In some implementations (not shown in these figures), the portion 605 of the metal frame 604 shown in FIG. 6B may be “carved out” of or formed from the metal frame 604 such that the coil is isolated from remaining portions of the metal frame 604.

As depicted in FIGS. 6A and 6B, the holes 616 may be of varying shape and size. As shown in FIG. 6B, the slits 618 may be straight lines between the holes 616 that they connect. In some implementations the slits 618 may be curved or any other shape. In some implementations, the holes 616 may be empty space, while in some other implementations, the holes 616 may be filled or partially filled with some non-conductive material (e.g., plastic, rubber, epoxy, polyurethane, or any other non-conductive material or combination thereof). In some implementations, the slits 618 may be empty space between the consecutive holes 616 that they each connect, while in some other implementations, the slits 618 may be filled or partially filled with some non-conductive material (e.g., plastic, rubber, epoxy, polyurethane, or any other non-conductive material or combination thereof).

The number of the holes 616 in the portion of the metal frame 604 may impact at least the resistance and the mutual inductance of the coil formed by the combination of the holes 616, the metal frame 604, and the slits 618. For example, the combination of holes 616, the top side 605 of the metal frame 604, and the slits 618 of FIG. 6B may form a coil having an inductance of 1013 nH, a resistance of 0.7Ω, a maximum mutual inductance of 855 nH, and a minimum mutual inductance of 697 nH.

TABLE 1

| | | | Mutual |
|---|---|---|---|
| # of holes | Inductance (nH) | Resistance (Ω) | Inductance (nH) |
| 0 | 384 | 1.1 | 350 |
| 1 | 429 | 0.8 | 368 |
| 2 | 439 | 0.7 | 374 |
| 3 | 454 | 0.7 | 382 |
| 4 | 468 | 0.7 | 396 |
| 5 | 485 | 0.6 | 411 |
| 6 | 492 | 0.6 | 424 |

The lower the resistance, the greater the energy transfer that is possible with the coil. Additionally, or alternatively, the higher the mutual inductance, the greater the energy transfer that is possible with the coil. Accordingly, the higher the resistance and the lower the mutual inductance, the lower the energy transfer that is possible with the coil. In some implementations, the amount of open space from the holes 616 in relation to the amount of metal material of the portion 605 of the metal frame 604 may determine the values shown in Table 1 above.

As shown in Table 1 above, as the number of holes 616 in the side of the metal frame 604 forming the coil increases, the resistance decreases because the parasitic capacitance between the individual turns of the coil decreases. Additionally, or alternatively, as the number of holes 616 in the side of the metal frame 604 forming the coil increases, the mutual inductance of the coil increases because eddy current is generated around the holes 616, and an increase in the number of holes 616 causes an increase in the eddy current, which increases an effective area of mutual coupling. In some implementations, a larger hole size can also increase mutual inductance, as more eddy current is induced about the holes 616. This eddy current may be induced by the magnetic field from the transmitter. The metal frame 604 may comprise the holes 616 at any position along the metal frame 604, so long as the holes 616 are connected through slits 618. For a given area or volume of the metal frame 604, a certain number of holes 616 are located near a center of the given area or volume, the formed coil may generate a first mutual inductance. This first mutual inductance may be higher than a second mutual inductance of the coil formed from the metal frame 604 and the name number and size of holes 616 and slits 618 positioned around an edge or perimeter of the metal frame 604. This is because if the holes 616 are positioned around the edge or perimeter, the most outer turn will be relatively farther away from the other turns, resulting in self-inductance of the coil to be lower.

FIG. 6C depicts a back view of the top side of the metal frame having the plurality of holes and slits including a protective layer and a plurality of wires. The back view of the top side 605 of the metal frame 604 shows a layer of protective materials between the back view of the top side 605 of the metal frame 604 and a returning bridge wire 620 connected to the center part of the coil. This returning bridge wire 620 may comprise the “return” of the coil and may be configured to connect one “end” of the coil to the circuit to which the entire coil is coupled (e.g., the transmitter circuit or the receiver circuit). In some implementations, the returning bridge wire 620 may be replaced by a metal tab or similar structure that protrudes from the circuit to contact the center of the coil or that protrudes from the center of the coil to contact the circuit. A second wire, a source wire 622, is shown contacting the bottom right corner of the top side 605 of the metal frame 604 shown in FIG. 6C. The source wire 622 may comprise the second point of contact between the coil and the circuit. In some implementations, the source wire 622 may be replaced by a metal tab or similar structure, either on the circuit or on the coil itself.

As described above, the combination of holes 616 and slits 618 may form a plurality of turns in the side of the metal frame 604. In addition to the number of holes, the number of turns formed in the coil may impact the inductance, resistance, and mutual inductance of the coil formed by the side of the metal frame 604, the holes 616, and the slits 618. As shown in Table 2 below, as the number of turns increases, the inductance, the resistance, and the mutual inductance all increase.

TABLE 2

| | | | Mutual Inductance |
|---|---|---|---|
| # of Turns | Inductance (nH) | Resistance (Ω) | (nH) |
| 1 | 258 | 0.4 | 305 |
| 2 | 502 | 0.6 | 546 |
| 3 | 829 | 0.7 | 716 |
| 4 | 1013 | 0.8 | 855 |

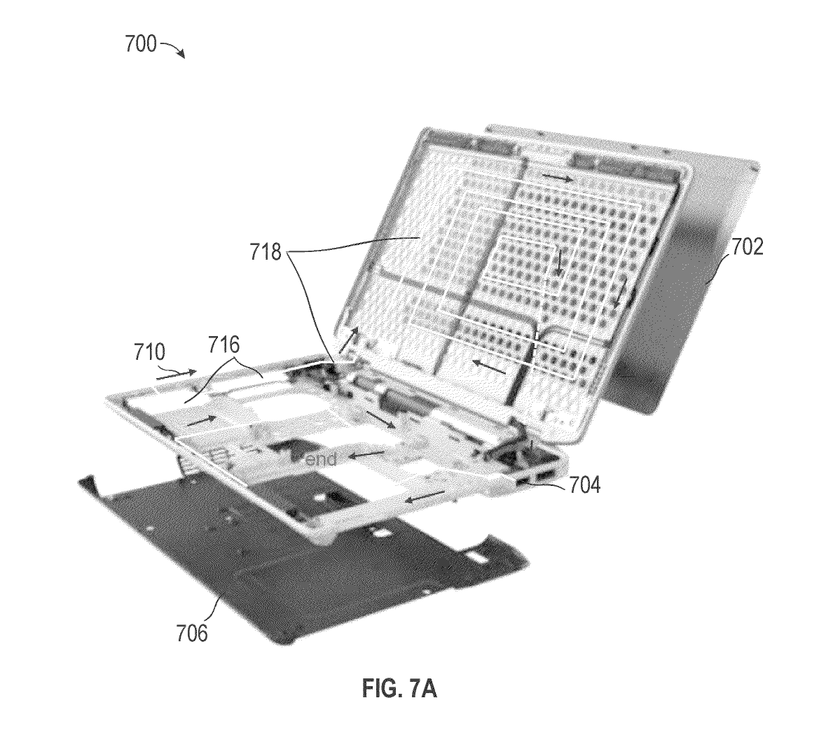

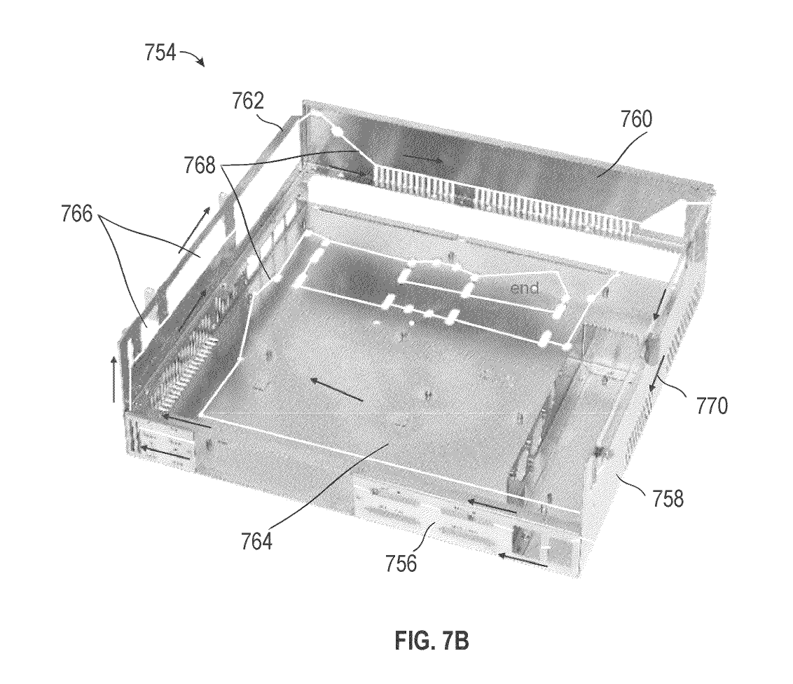

FIGS. 7A and 7B show examples of electronic devices having metal frames adapted to operate as a resonator for wireless power transfer. FIG. 7A depicts an exploded perspective view of a laptop computer having a plurality of holes and slits arranged to form a coil from the laptop chassis. The laptop 700 is shown having a plastic lid 702, a metal chassis 704, and a plastic bottom 706. The metal chassis 704 of the laptop 700 includes multiple holes 716. A series of slits 718 is shown forming a coil from the metal chassis 704 of the laptop 700. Arrows 710 indicate an example of a direction of current flow through the coil formed from the metal chassis 704. As shown in the FIG. 7A, the coil formed from the metal chassis 704 may comprise five loops, where the loop begins on a left side of the base of the metal chassis 704 and ends in a middle of the right side of the base of the metal chassis 704.

FIG. 7B depicts a perspective view of a desktop computer chassis having a plurality of holes and slits arranged to form a coil from the desktop computer chassis. In the implementation shown, the desktop chassis 754 is shown having various vertical and horizontal sides. For example, the desktop chassis 754 includes a front side 756, a right side 758, a back side 760, a left side 762, and a bottom side 764. The metal chassis 754 includes multiple holes 766. A series of slits 768 is shown forming a coil from the metal chassis 754. Arrows 770 indicate an example of a direction of current flow through the coil formed from the metal chassis 754. In some implementations, the multiple sides of the desktop chassis 754 may be connected to form a single coil. As shown in the FIG. 7B, the coil formed from the metal chassis 754 may comprise three loops, where the loop begins on a bottom right side of the base of the front side 756 of the metal chassis 754 and ends in a middle of the bottom side 764 of the metal chassis 754.

In some implementations, the metal chassis of the electronic device may be configured to operate as a communication antenna, for example, for cellular or Wi-Fi communications standards. In some implementations, the top side 605 of the metal frame 604 may be further modified to include capacitors or inductors that may be configured to alter the coil formed by the holes 616, slits 618, and the top side 605 of the metal frame 604. Further details regarding the use of one or more portions of the metal frame 604 as a communication antenna will be discussed below.

In some implementations, when the various sides of the desktop chassis 754 of FIG. 7B are not connected to form a single coil, multiple coils may be formed from individual sides of the desktop chassis 754. In some embodiments, each of the sides of the desktop chassis 754 may be have a plurality of holes and slits positioned to form a multi-turn coil from the side of the desktop chassis 754 (e.g., a back side 760 may form multi-turn coil while the right side 758 and the front side 756, etc., each form multi-turn coils as well). In some embodiments, the individual coils formed from the different sides of the desktop chassis 754 may have different numbers of turns, holes 766, and slits 768.

In some embodiments when the multiple coils are formed from the individual sides of the desktop chassis 754, one coil may be formed to perform high frequency communications (e.g., forming a WWAN coil) while another coil may be configured to perform low frequency tasks such as wireless power transfer and a third coil may be configured to perform near-field communication (NFC) or radio frequency identification (RFID) tasks. When the multiple coils are formed from the desktop chassis 754, one or more switches may be utilized to selective couple one of the multiple coils to the transmitter or receiver circuit of the electronic device. For example, a coil formed from the back side 760 of the desktop chassis 754 may be configured to function as a low frequency coil (e.g., wireless charging coil). A coil formed from the front side 756 of the desktop chassis 754 may be configured to function as a high frequency coil (e.g., the WWAN coil). A coil formed from the right side 758 of the desktop chassis 754 may be configured to function as the NFC or RFID coil. The switch described above may selectively couple one or more of these coils to the transmitter or receiver circuits described above. In some embodiments, the multiple coils formed from the different sides of the desktop chassis 754 may each be simultaneously coupled to the transmit or receive circuit so as to enable to device comprising the desktop chassis 754 to be positioned in a variety of positions without losing the wireless communication or power transfer capabilities of the coils. In some implementations, the switch may be configured to selectively couple one or more coils formed from different sides of the desktop chassis 754 to a single receiver. In some implementations, coils formed from portions of the metal frame desktop chassis 754 facing or projecting in different or orthogonal directions may be used for receiving different directional components of the field. For example, the coil formed from the back side 760 may couple to a vertical component of the magnetic field, while the coil formed from the right side 758 may couple to horizontal component of the magnetic field.

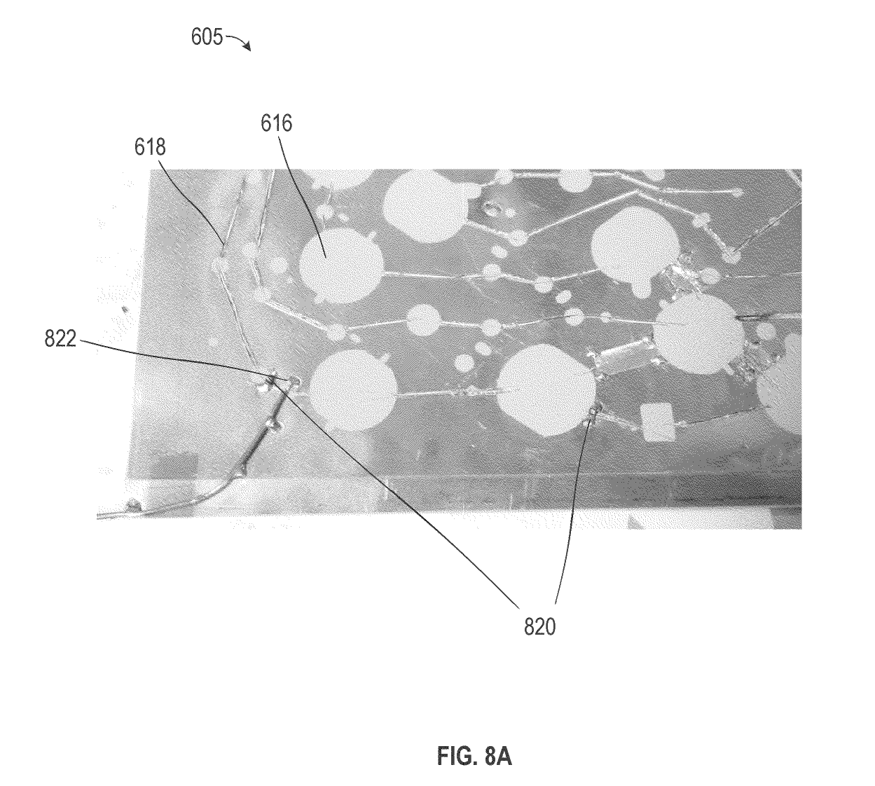

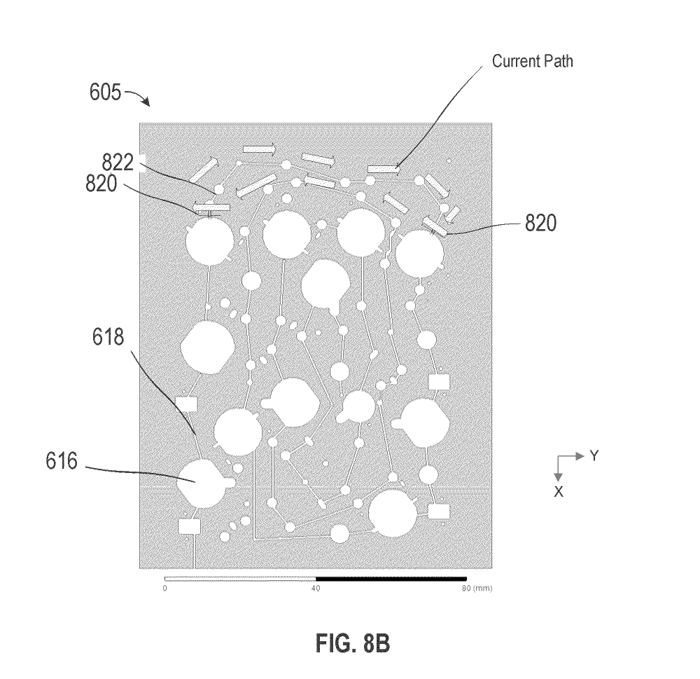

FIG. 8A depicts an image of the coil formed by the top side of the metal frame having one or more components that create a slot antenna having a current path about the slits and the holes. The multi-turn coil formed by the top side 605 of the metal frame 604, the holes 616, and the slits 618 may have the one or more capacitors, inductors, or bandpass or bandstop filters 820 and a feed connection 822. The one or more capacitors, inductors, or bandpass or bandstop filters 820 may bridge one or more of the slits that form the multi-turn coil formed by the top side 605. The one or more capacitors, inductors, or bandpass or bandstop filters 820 may create a short circuit between one or more adjacent turns of the coil at particular frequencies (for example, LTE, Wi-Fi, GPS, etc., frequencies) while creating an open circuit between the adjacent turns at other frequencies (for example, 6.78 MHz, etc.). In some implementations, the one or more capacitors, inductors, or bandpass or bandstop filters 820 may create short circuits at high frequencies (e.g., above 10 MHz) and be open at low frequencies (e.g., below 10 MHz). By creating the short circuit at high frequencies, the capacitors, inductors, or filters 820 may effectively “create” a single turn coil from the multi-turn coil formed by the top side 605 for use with high frequency communications. Accordingly, the “same” multi-turn coil may be configured for use with both wireless power (low frequencies) and wireless communication protocols (high frequency). In some implementations, a single inductor or capacitor may be sufficient, dependent upon its placement in relation to the coil formed from the top side 605. For example, at high frequencies, since a wavelength is just millimeters in length, a single inductor or capacitor may be placed around a single hole 616. Thus, at a high frequency such as 5.8 GHz, the capacitor 820 shorting the multi-turn coil on one side of a hole 616 opposite the feed connection 822 may create a slot antenna with only the hole 616 forming the slot. In some implementations, when using a bandpass or bandstop filter, both the inductor and the capacitor may be used in series or in parallel.

The feed connection 822 may correspond to one location at which the transmitter or receiver circuit is coupled to the multi-turn coil formed by the top side 605 of the metal frame. In some implementations, the feed connection 822 may comprise a coaxial cable, with one lead coupled to a first “side” of the multi-turn coil (e.g., on a first side of a slit 618 or hole 616) and the other lead coupled to a second side of the multi-turn coil.

FIG. 8B depicts another view of the coil forming the slot antenna of FIG. 8A showing the current path about the slits and the holes of the top side of the metal frame. As shown in FIG. 8A, the multi-turn coil of FIG. 8B is formed from the top side 605 of the metal frame. The coil comprises a plurality of slits 618 and holes 616. The multi-turn coil is also shown with the capacitors 820 placed near the top of the multi-turn coil. In some implementations, the capacitors 820 may be replaced with inductors or filters or other similar acting components. The capacitors 820 may form a slot antenna from a portion of the multi-turn coil of the top side 605 of the metal frame.

When the capacitors 820 are exposed to a high frequency, the capacitors 820 act as short circuits, and, thus, the multi-turn coil formed from the top side 605 of the metal frame is short circuited at the locations of the capacitors 820. The short circuited portion may effectively form a single turn coil or slot antenna about the slits 618 and holes 616 between the capacitors 820 with the feed connection 822. The feed connection 822 may be located in between the two capacitors where the antenna input impedance matches system reference impedance, for instance, 50 ohms.

In some implementations, the slot antenna may be formed having a specific size based on the desired communication frequency. For example, the capacitors 820 that form the slot antenna from the multi-turn coil may be positioned in varying locations to adjust a size of the formed slot antenna. For example, the approximate size of the slot antenna may be determined based on Equation 1 below:

L=λ/2 or L=λ/4 (Equation 1)

### In Equation 1:

L=approximate length of the slot antenna; and

λ=wavelength of the desired communication frequency.

Accordingly, for a desired communication frequency of 950 MHz, the length of the slot antenna may be approximately 6 inches. In some implementations, the length of the slot antenna may be further affected by sizes of any holes 616 or thicknesses of any slits 618 that form the slot antenna. For example, the slot antenna formed only from one or more slits 618 may have a longer linear slot length than the slot antenna formed from a combination of slits 618 and holes 616. The slot antenna length may be affected by any surrounding materials, for example, a molded plastic to hold and fill the slot (e.g., the slits 618 and/or the holes 616). When the plastic (or similar insulating material) is present, the slot length can be further decreased. Thus, the slot antenna formed between the capacitors 820 may not be exactly 6 inches in length based on the composition of holes 616 and 618 forming the slot antenna.

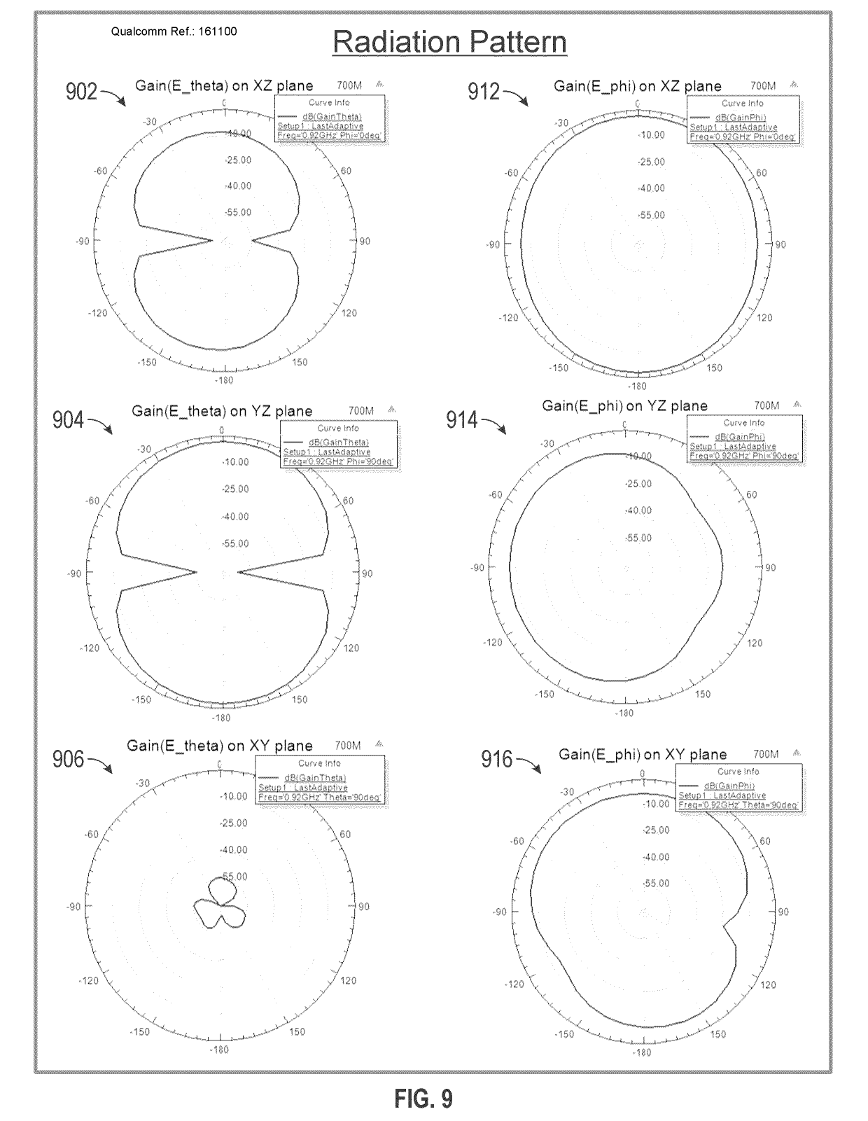

FIG. 9 depicts a series of graphs indicating radiation patterns of the slot antenna of FIG. 8B. As shown in the graphs, the radiation pattern of the slot antenna (three graphs 902, 904, and 906) formed between the capacitors 820 in FIG. 8B is similar to the radiation pattern of a dipole antenna (three graphs 912, 914, and 916) configured to communicate at the same frequency. Each of the graphs 902 and 912 shows omni-directional radiation of an E (phi) component on an XZ plane and nulls of the same component when a theta (elevation angle) is equal to 90 or −90 degrees. Similar radiation patterns are also observed on YZ (graphs 904 and 914) and XY (graphs 906 and 916) planes. Accordingly, the communication capabilities of the slot antenna formed from the multi-turn coil of the top side 605 of the metal frame has similar communication characteristics as a dipole antenna configured for communication at the same frequency.

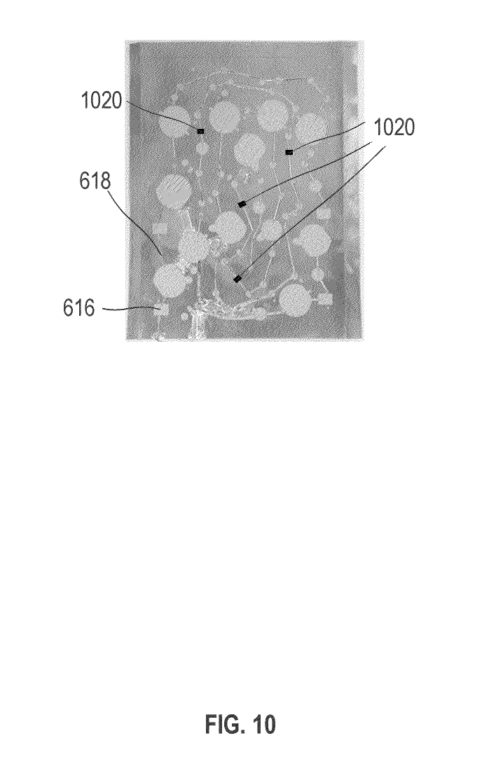

FIG. 10 depicts an image of the coil formed from the top side of the metal frame being adapted for improved electromagnetic interference reduction and mechanical robustness, in accordance with an exemplary implementation. The multi-turn coil formed from the top side 605 of the metal frame comprises the plurality of holes 616 and slits 618. The multi-turn coil may further include one or more capacitors, inductors, or filters 1020. The one or more capacitors, inductors, or filters 1020 (e.g., the capacitors 820) may be configured to couple portions of the multi-turn coil, thereby creating shorts across the slits 618 or holes 616 of the multi-turn coil at high frequencies. Additionally, one or more portions of the multi-turn coil may be coupled to a reference ground (not shown) at one or more locations (not shown).

Additionally, in some implementations, one or more portions of the multi-turn coil may be coupled to a reference ground 1005 at one or more locations. As electromagnetic interference (EMI) currents may stray anywhere on the top side 605 of the metal frame forming the multi-turn coil, a direct electrical contact from the top side 605 of the metal frame to a circuit board reference ground, i.e. via a vertical contact to a ground of the receive circuit. In order to avoid creating shorts at the wireless charging frequency or at communication frequencies, this vertical contact may have a capacitor (or similar component, e.g., inductor, etc.) at or between the connection at the top side 605 of the metal frame and a corresponding connection on the circuit board. In some implementations, multiple direct electrical contacts between the top side 605 of the metal frame and the circuit board may exist.

A value of capacitance for the capacitor coupled between the top side 605 of the metal frame and the circuit board may be selected based on a frequency of EMI to be suppressed. In some implementations where the desired EMI suppression is within a frequency band overlapped by desired communication and wireless transfer frequencies, the same capacitance values may be used for both EMI suppression and multi-turn coil shorting (e.g., creating the slot antennas from the multi-turn coil). In some implementations where the desired EMI suppression frequency band is below the desired communication and/or wireless transfer frequency bands, different capacitance values may be used for both the EMI suppression and the multi-turn coil shorting (e.g., creating the slot antennas from the multi-turn coil). In some implementations, the capacitors 1020 may also function as the capacitors 820, e.g., where the EMI and transfer frequency bands overlap.

By coupling the one or more portions of the multi-coil antenna to the reference ground, the one or more portions may be protected from EMI to which the top side 605 of the metal frame is exposed. The multi-turn coil, the capacitors 1020, and the reference ground contact locations may be configured and/or positioned such that one or more antenna configurations of the multi-turn coil (e.g., the 950 MHz communication antenna, the 6.78 MHz wireless power multi-turn coil, etc.) are each coupled to the reference ground, regardless of the configuration of the multi-turn coil. For example, when the multi-turn coil is shorted to create the 950 MHz communication slot antenna described herein, the slot antenna may be coupled to the reference ground through a first reference ground contact (not shown) that is located between the two capacitors 820 of FIGS. 8A and 8B along the multi-turn coil forming the slot antenna. When the multi-turn coil is shorted to create a 11 MHz communication antenna, the first reference ground contact may be not be an option for the 11 MHz communication antenna due to its configuration from the multi-turn coil. Accordingly, a second reference ground contact (not shown) located within the 11 MHz communication antenna may couple the 11 MHz communication antenna to the reference ground. Placement of the reference ground contacts may be determined based on EMI distribution along the associated portions of the metal frame and/or the multi-turn coil or slot antenna.

In some implementations, the capacitors 1020 may provide for selective grounding of one or more portions of the multi-turn coil to the reference ground. The capacitors 1020 providing grounding to the reference ground (via the reference ground locations) or the capacitor between the multi-turn coil and the circuit board may be configured to present a high impedance at the desired transfer frequency (e.g., at 6.78 MHz when wireless charging at 6.78 MHz is desired) and a low impedance at EMI frequencies (generally higher than the desired transfer frequency).

Additionally, in some implementations, one or more of the holes 616 or the slits 618 may be filled with a non-conductive, rigid material. For example, one or more of the holes 616 or slits 618 may be filled with a rigid plastic or carbon glass fiber material. Additionally, one or more screws may be used to hold the metal frame in place. Accordingly, the combination of the filler material and the one or more screws may provide for a mechanically robust multi-turn coil and/or slot antenna.

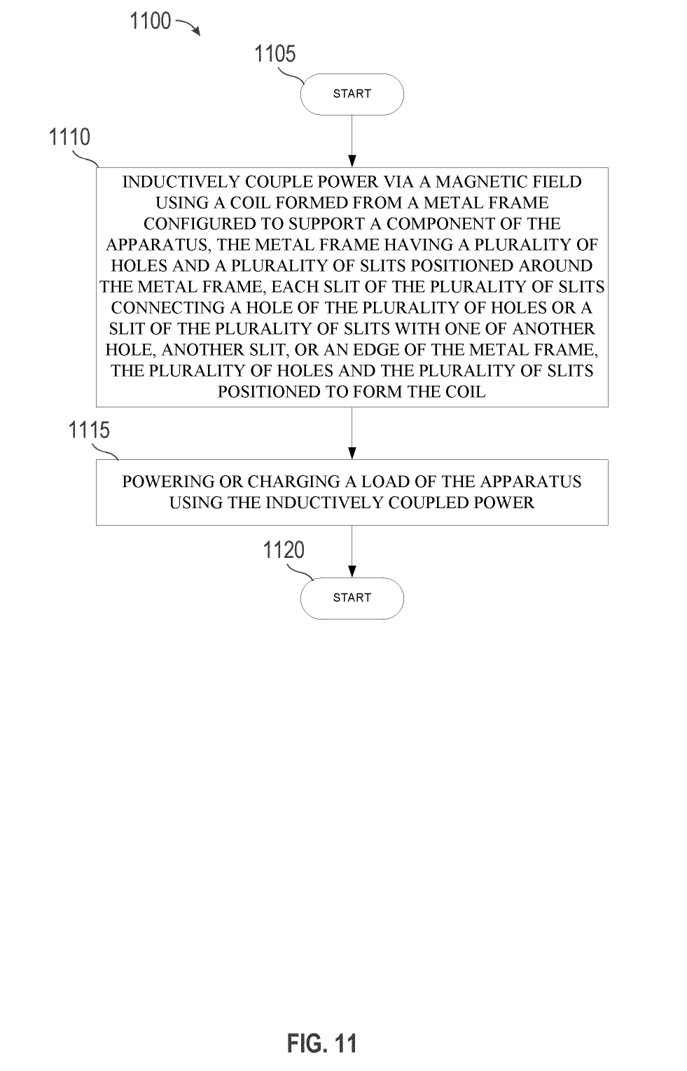

FIG. 11 depicts a flowchart of an exemplary method 1100 of wirelessly receiving power at an apparatus from a transmitter, in accordance with an exemplary implementation. In an implementation, the metal frame 604 of FIG. 6 may perform the method 1100. In some implementations, one or more portions or sides 605, 606, or 607 may perform the method 1100.

The method 1100 begins as block 1105 and proceeds to block 1110. At block 1110, power is inductively coupled via a magnetic field using a coil formed from a metal frame. The metal frame may be configured to support a component of the apparatus. The metal frame has a plurality of holes and a plurality of slits positioned around the metal frame, each slit of the plurality of slits connecting a hole of the plurality of holes or a slit of the plurality of slits with one of another hole, another slit, or an edge of the metal frame, the plurality of holes and the plurality of slits positioned to form the coil. The plurality of holes may comprise the holes 616 while the plurality of slits may comprise the slits 618.

At block 1115, a load is powered or charged using the inductively coupled power. The load may comprise load 550 of FIG. 5, which may comprise one or more of the components of the metal frame 604.

Additionally, in some implementations, one or more of the holes 616 or the slits 618 may be filled with a non-conductive, rigid material. For example, one or more of the holes 616 or slits 618 may be filled with a rigid plastic or carbon glass fiber material. Additionally, one or more screws may be used to hold the metal frame in place. Accordingly, the combination of the filler material and the one or more screws may provide for a mechanically robust multi-turn coil and/or slot antenna.

The various operations of methods performed by the apparatus or system described above may be performed by any suitable means capable of performing the operations, such as various hardware and/or software component(s), circuits, and/or module(s). Generally, any operations or components illustrated in the Figures may be performed or replaced by corresponding functional means capable of performing the operations of the illustrated components. For example, a means for inductively coupling may comprise a metal frame 604 (FIG. 6) comprising a plurality of holes 616 and slits 618 extending substantially around at least a portion of the metal frame 604. In some implementations, the means for inductively coupling may comprise the metal frame 604 having the plurality of holes 616 and slits 618 positioned so as to form a coil (for example, multi-turn coil) from the metal frame 604. In some implementations, the means for inductively coupling power via the magnetic field may include a transmit coupler 404 (FIG. 4) or a receive coupler 504 (FIG. 5) that may include the coil formed from the metal frame 604. Furthermore, means for powering or charging a load may include receive circuitry 502 (FIG. 5).

For example, a means for inductively coupling may comprise a metal frame 604 (FIG. 6). In some implementations, a means for communicating comprises the metal frame 604 having the plurality of holes 616 and slits 618 arranged to form a coil from the metal frame 604. In some implementations, the means for inductively coupling and the means for communicating may share the coils formed from the metal frame 604 having the plurality of holes 616 and slits 618, further comprising a means for electrically generating a short or open circuit. In some implementations, the means for electrically generating a short or open circuit comprises one or more capacitors or inductors configured to couple one turn of the coil formed from the metal frame 604 to an adjacent turn of the coil formed from the metal frame 604. In some implementations, the means for communicating may include a transmit coupler 404 (FIG. 4) or a receive coupler 504 (FIG. 5) that may include the coil formed from the metal frame 604. Furthermore, the means for communicating may include transmit circuitry 402 (FIG. 4) or receive circuitry 502 (FIG. 5).

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions may not be interpreted as causing a departure from the scope of the implementations of the invention.

The various illustrative blocks, modules, and circuits described in connection with the implementations disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the implementations disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor may read information from, and write information to, the storage medium. In the alternative, the storage medium may be integral to the processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above may also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular implementation of the invention. Thus, the invention may be embodied or carried out in a manner that achieves or optimizes one advantage or group of advantages as taught herein without necessarily achieving other advantages as may be taught or suggested herein.

Various modifications of the above described implementations will be readily apparent, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. An apparatus for wirelessly receiving power from a transmitter, comprising:
a metal frame configured to support a component of the apparatus and having a plurality of holes and a plurality of slits, each slit of the plurality of slits connecting a hole of the plurality of holes or a slit of the plurality of slits with one of another hole, another slit, or an edge of the metal frame, the plurality of holes and the plurality of slits positioned to form a coil from the metal frame; and
a receive circuit comprising the coil and configured to inductively couple power via a magnetic field generated by the transmitter to power or charge a load electrically coupled to the receive circuit.

2. The apparatus of claim 1, wherein the coil formed from the metal frame is a multi-turn coil.

3. The apparatus of claim 2, further comprising:
one or more electronic devices configured to create a short between at least two adjacent turns of the multi-turn coil;
a communication circuit comprising the shorted coil and configured to transmit or receive communications via the shorted coil; and
a switch, the switch configured to selectively couple at least one of the receive circuit or the communication circuit to the multi-turn coil and the shorted coil, respectively.

4. The apparatus of claim 3, wherein the one or more electronic devices comprise at least one of a capacitor, an inductor, and a filter.

5. The apparatus of claim 3, wherein the shorted coil is used for communication purposes.

6. The apparatus of claim 1, further comprising a ground component configured to couple the metal frame to a reference ground and reduce electromagnetic interference at one or more frequencies.

7. The apparatus of claim 1, wherein the coil formed from the metal frame is configured to form part of a resonant circuit configured to inductively couple the power via the magnetic field.

8. The apparatus of claim 1, wherein each hole of the plurality of holes is configured to permit access to at least one of a camera lens, a light source, a speaker, a microphone, a charging port, a data port, an audio port, or a user interface device.

9. The apparatus of claim 1, wherein one or more holes of the plurality of holes is filled with at least one of a plastic, or a rubber, or an epoxy material, or a combination thereof.

10. The apparatus of claim 1, wherein one or more slits of the plurality of slits is filled with at least one of a plastic, or a rubber, or an epoxy material, or a combination thereof.

11. The apparatus of claim 1, wherein the coil formed from the metal frame is configured to generate a current in response to a voltage induced by the magnetic field.

12. The apparatus of claim 1, wherein another metal frame coupled to the metal frame comprises another plurality of holes and another plurality of slits positioned around the other side, each slit of the other plurality of slits connecting two or more holes of the other plurality of holes, the other plurality of holes and the other plurality of slits positioned to form another coil from the other metal frame.

13. The apparatus of claim 12, further comprising a switch configured to selectively couple at least one of the coil of the metal frame and the other coil of the other metal frame to the receive circuit.

14. The apparatus of claim 1, further comprising another metal frame coupled to the metal frame, the other metal frame comprising another plurality of holes and another plurality of slits positioned around the other metal frame, each slit of the other plurality of slits connecting two or more holes of the other plurality of holes, the other plurality of holes and the other plurality of slits positioned to form another coil from the other metal frame, wherein the coil formed from the metal frame and the other coil formed from the other metal frame are configured to form a single combined coil.

15. The apparatus of claim 14, wherein the coil formed from the metal frame and the coil formed from the other metal frame are in different planes.

16. The apparatus of claim 1, wherein the metal frame is configured as at least a portion of a frame of at least one of a cellular phone, a GPS unit, a watch, a mobile media device, a laptop computer, a desktop computer, a key fob, or a tablet.

17. The apparatus of claim 1, wherein the metal frame is configured as a frame of a portable electronic device.

18. The apparatus of claim 1, wherein the coil formed from the metal frame couples to a vertical component of the magnetic field, while another coil formed from another metal frame that is orthogonal to the metal frame couples to a horizontal component of the magnetic field.

19. An apparatus for wirelessly receiving power from a transmitter, comprising:
a casing;
a frame having:
a shape defined to provide structural support for the apparatus,
one or more holes defining positioned around the frame so as to provide access between an inside and an outside of the frame, and
one or more slits configured to connect a hole of the one or more holes or a slit of the one or more slits with one of another hole, another slit, or an edge of the metal frame; and
a receive circuit comprising a metal portion forming a portion of the frame, the metal portion having the one or more holes and the one or more slits, the receive circuit configured to inductively couple power via a magnetic field generated by the transmitter to power or charge a load electrically coupled to the receive circuit, the metal portion of the frame having the one or more holes and the one or more slits defining a path for electrical current to flow in the metal portion substantially around the frame in response to a voltage induced by the magnetic field.

20. A method of wirelessly receiving power at an apparatus from a transmitter, comprising:
inductively coupling power via a magnetic field generated by the transmitter via a receive circuit comprising a coil formed from a metal frame configured to support a component of the apparatus, the metal frame having a plurality of holes and a plurality of slits positioned around the metal frame, each slit of the plurality of slits connecting a hole of the plurality of holes or a slit of the plurality of slits with one of another hole, another slit, or an edge of the metal frame, the plurality of holes and the plurality of slits positioned to form the coil; and
powering or charging a load of the apparatus using the inductively coupled power.

21. The method of claim 20, wherein the coil formed from the metal frame is a multi-turn coil.

22. The method of claim 21, further comprising:
creating a short between at least two adjacent turns of the multi-turn coil;
transmitting or receiving communications via the shorted coil; and
selectively coupling at least one of a wireless power circuit or a communication circuit to the multi-turn coil and the shorted coil, respectively.

23. The method of claim 22, wherein the short is created using at least one of a capacitor, an inductor, and a filter.

24. The method of claim 22, wherein the shorted coil is used for communication purposes.

25. The method of claim 20, further comprising couple the metal frame to a reference ground and reducing electromagnetic interference on the metal frame at one or more frequencies.

26. The method of claim 20, wherein the coil formed from the metal frame is configured to form part of a resonant circuit inductively couples the power via the magnetic field.

27. The method of claim 20, wherein at least one hole of the plurality of holes permits access to at least one of a camera lens, a light source, a speaker, a microphone, a charging port, a data port, an audio port, or a user interface device.

28. The method of claim 20, wherein one or more holes of the plurality of holes is filled with at least one of a plastic, or a rubber, or an epoxy material, or a combination thereof.

29. The method of claim 20, further comprising:
inductively coupling power via the magnetic field generated by the transmitter via another coil of the receive circuit, the other coil formed from another metal frame configured to support at least one of the component or another component of the apparatus, the other metal frame having another plurality of holes and another plurality of slits positioned around the other metal frame, each slit of the other plurality of slits connecting a hole of the other plurality of holes or a slit of the other plurality of slits with one of another hole, another slit, or an edge of the other metal frame, the other plurality of holes and the other plurality of slits positioned to form the other coil; and
powering or charging a load of the apparatus using the inductively coupled power.

30. An apparatus for wirelessly receiving power from a transmitter, comprising:
means for inductively coupling power via a magnetic field generated by the transmitter, wherein a current induced by the magnetic field has a current path about a plurality of holes and a plurality of slits, each slit of the plurality of slits connecting a hole of the plurality of holes or a slit of the plurality of slits with one of another hole, another slit, or an edge of the metal frame; and
means for powering or charging a load of the apparatus using the inductively coupled power.
